(19) United States
(12) Patent Application Publication
(10) Pub. No.: US 2009/0114683 A1
(43) Pub. Date: May 7, 2009

(54) AUTOMATIC CONTINUOUS SPRAYER WITH ENERGY STORAGE ELEMENT AND RELATED METHOD THEREOF

(76) Inventor: LEE-WEI CHOU, Pinole, CA (US)

Correspondence Address: LEONG C LEI, PMB # 1008, 1867 YGNACIO VALLEY ROAD, WALNUT CREEK, CA, 94598, US

(21) Appl. No.: 11/934,797

(22) Filed: Nov. 5, 2007

(51) Int. Cl. B67D 5/40; G01F 11/00

(52) U.S. Cl. 222/383.1; 222/1

(57) ABSTRACT

The sprayer of the present invention has a conventional first lever and a second lever with continuous teeth along an edge. When the first lever is engaged, the second lever drives a rotatable piece inside a gravity wheel. Two blocks at the ends of the rotatable piece, as the rotatable piece turns, press some ratchets inside the gravity wheel to turn the gravity wheel. The gravity wheel in turn drives a gear set connected to an energy storage element such as a winding spring. The gear set further engages an eccentric gear with a shaft attached to it so. As the energy storage element is wound and unwound, the shaft is put into continuous back-and-forth movement to work on a pump of the sprayer. As such, a number of sprays are produced continuously.

(a) Technical Field of the Invention

The present invention generally relates to sprayers, and more particularly to a sprayer capable of producing continuous sprays through an energy storage element and a related method thereof.

(b) Description of the Prior Art

Sprayers are commonly found in daily life for spraying deodorants or detergents or other types of liquids. A conventional sprayer, as shown in FIG. 1, is operated by manually exercising an external force on a lever of the sprayer to pressurize the liquid contained in a container to flow through a dip tube and then spray in a mist.

Despite that many improvements have been disclosed for the sprayer, most of them still produce a single spray when the lever is engaged once. If a larger amount of mist is required, the user has to continuously engage the lever. This is a laborious process and the speed in producing the required amount of mist is also slow.

### SUMMARY OF THE INVENTION

Therefore, a novel sprayer and a related method are provided herein.

The sprayer of the present invention has a conventional first lever and a second lever with continuous teeth along an edge. When the first lever is engaged, the second lever drives a rotatable piece inside a gravity wheel. Two blocks at the ends of the rotatable piece, as the rotatable piece turns, press some ratchets inside the gravity wheel to turn the gravity wheel. The gravity wheel in turn drives a gear set connected to an energy storage element such as a winding spring. The gear set further engages an eccentric gear with a shaft attached to it so. As the energy storage element is wound and unwound, the shaft is put into continuous back-and-forth movement to work on a pump of the sprayer. As such, a number of sprays are produced continuously.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing the operation of a conventional sprayer.

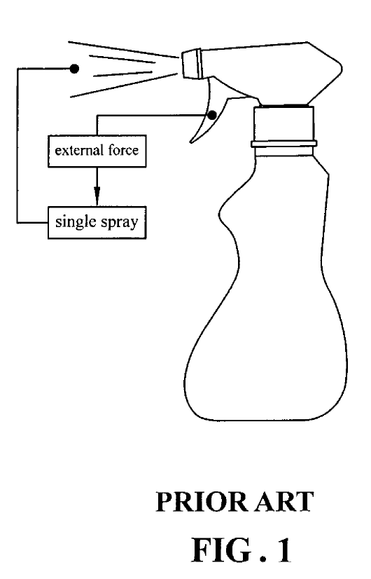

FIG. 2 is a schematic view showing the operation principle behind the present invention.

FIG. 3 is a schematic view showing the process of transforming external linear pressure into continuously back-and-force force.

FIG. 4 is a profile view showing a sprayer according to an embodiment of the present invention.

FIG. 5 is a perspective view showing a sprayer according to another embodiment of the present invention.

FIG. 6 is a schematic view showing the inside of the sprayer of FIG. 4 before a first lever is engaged.

FIG. 7 is a schematic view showing the inside of the sprayer of FIG. 4 after a first lever is engaged.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

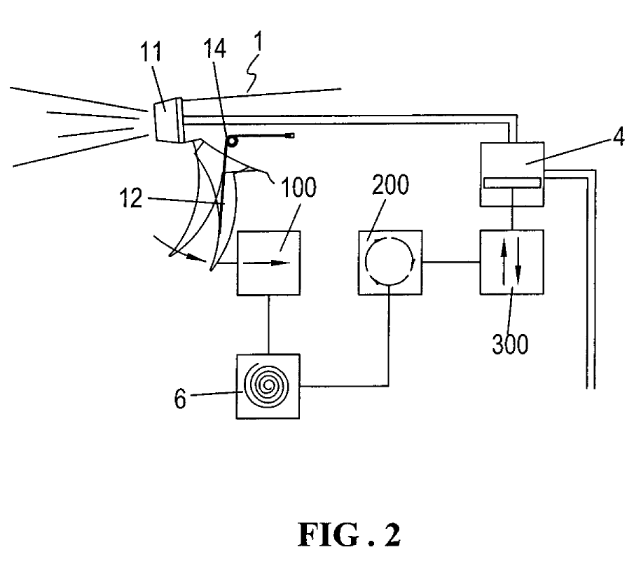

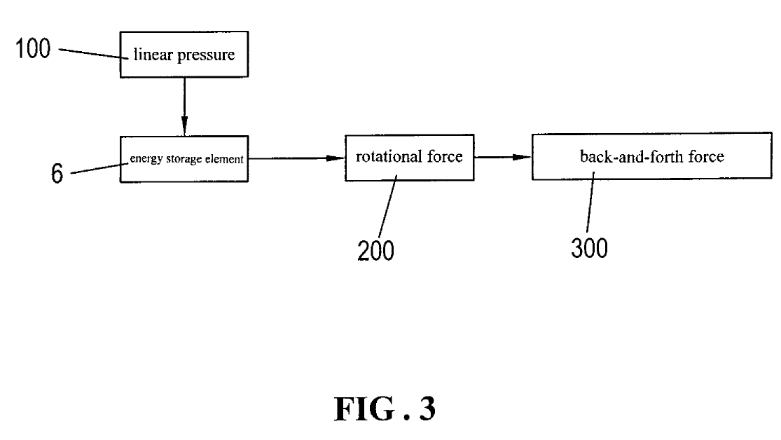

As shown in FIGS. 2 and 3, the method of the present invention in achieving continuous sprays is as follows. An energy storage element 6 is used to store the mechanical energy from applying a linear pressure 100 exerted on a lever 12 of a sprayer 1. When the stored energy is released, it is turned into a rotational force 200 whose direction is changed intermittently. The rotational force 200 in turn is converted into a back-and-forth force 300 on a pump 4 of the sprayer 1. Continuous sprays from a nozzle 11 are thereby produced.

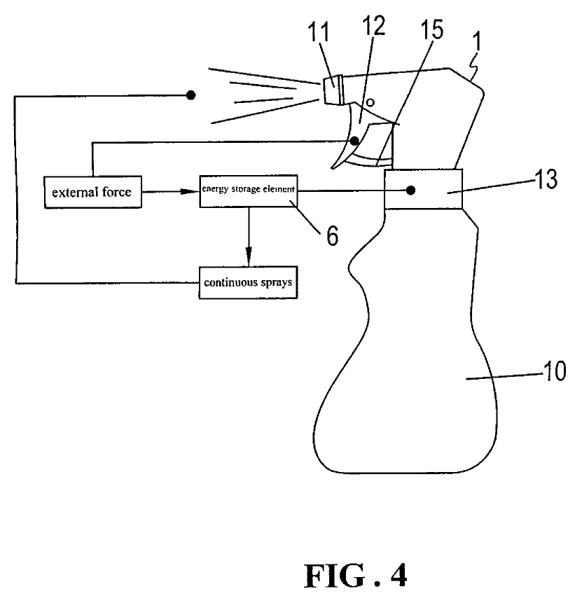

As shown in FIGS. 4 to 7, an automatic continuous sprayer 1 according to an embodiment of the present invention is mounted on a container 10 via a container cap 13 on a top opening of the container 10.

The sprayer 1 has a hollow and approximately L-like body. A nozzle 11 is provided on a front end of the sprayer 1 and the other end of the sprayer 1 is joined with the container cap 13. In addition, a curved first lever 12 is provided between the two ends of the L-shaped body. In turn, a curved second lever 15 has a first end fixedly joined to a lower portion of the first lever 12 and a second end extended into a lower portion of the body of the sprayer 1. Please note that continuous teeth are provided along a top edge of the second lever 15 from the second end towards the first end for an appropriate distance. The top edge of the second lever 15 then has a plain, no-tooth segment 151 up to the first end.

A resilient element 14 is provided between the body and the first lever 12. In the present embodiment, a torsion spring is used as the resilient element 14 so that, after the lever 12 is engaged to compress the resilient element 14 and then released, the first lever 12 is restored to its original, non-engaged position as the resilient element 14 expands.

Inside the body of the sprayer 1, the teeth of the second lever 15 engages a rotatable piece 52 inside a gravity wheel 25. When a linear pressure is exerted on the first lever 12, the linear pressure is converted into a rotational force whose direction is changed intermittently, via the second lever 15 and the gravity wheel 25.

To achieve that inside the gravity wheel 25, there are a number of ratchets 51 around the inner circumference and the rotatable piece 52 is diametrically and pivotally mounted inside the gravity wheel 25. When the rotatable piece 52 is engaged by the second lever 15, the rotatable piece 52 spins inside the gravity wheel 25. A flexible block 53 is provided at the two ends of the rotatable piece 52, respectively, to interact with the ratchets 51. The ratchets 51, the rotatable piece 52, and the blocks 53 jointly form a clutch means 5.

When a linear pressure is exerted to press the first lever 12 towards the body of the sprayer 1, the second lever 15 engages the rotatable piece 52, the blocks 53 presses against some of the ratchets 51, and the gravity wheel 25 is rotated synchronously. As the gravity wheel 25 is turned, the blocks 53 may break away from the ratchets 51 and the gravity wheel 25 may turn freely in the opposite direction until the blocks 53 again press against some ratchets 51.

The rotational force is further converted to a continuous back-and-forth force by a gear set 2 and an eccentric means 3. The gravity wheel 25 engages a gear set 2 so that the gear set turns synchronously with the gravity wheel 25.

An energy storage element 6 is connected to the gear set 2. In the present embodiment, the energy storage element 6 is winding spring 61 such as one found in the clockwork. When the gear set 2 is turned synchronously as the rotatable piece 52 engages the gravity wheel, the spring 61 is wound and mechanical energy is stored in the spring 61 and, when the gravity wheel 25 is allowed to turn freely in an opposite direction, the spring 61 is unwound automatically to release the stored energy. As such, the gear set 2 is able to turn in an opposite direction with greater speed and force.

The gear set 2 in turn engages an eccentric means 3 which contains an eccentric gear 31 engaged by the gear set 2, and a T-shaped shaft 32 having an elongated hole 321 on one end connected to the eccentric gear 31. The shaft 32 has the other end directly pressed against a pump 4 also inside the body. As such, the rotation force on the eccentric gear 31 by the gear set 2 is converted into a back-and-forth movement of the shaft 32 and the pump 4 is continuously engaged by the shaft 32 to produce a number of sprays automatically from the nozzle 11.

When the first lever 12 is pressed until the plain segment 151 has reached the rotatable piece 52, the gravity wheel 25 is allowed to turn feely as the rotatable piece 52 is no longer engaged by the second lever 15's teeth. As such, all the stored energy of the spring 61 is released completely and the spring 61 is ready for the next operation on the first lever 12.

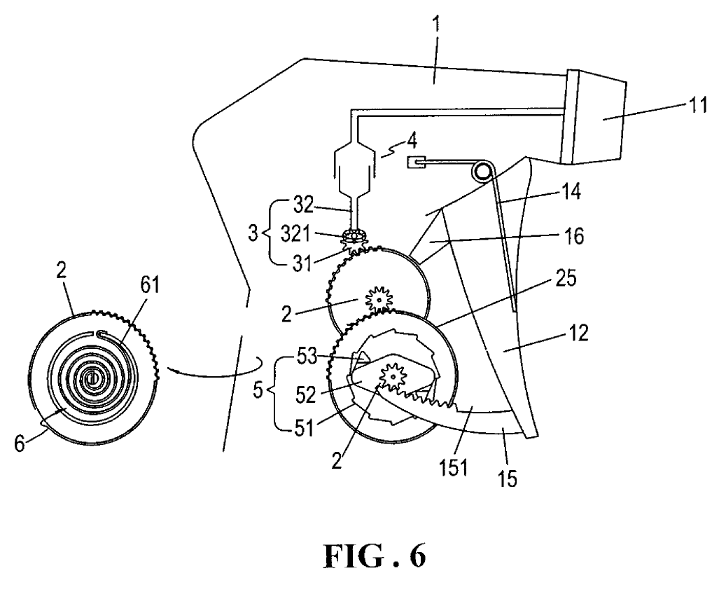

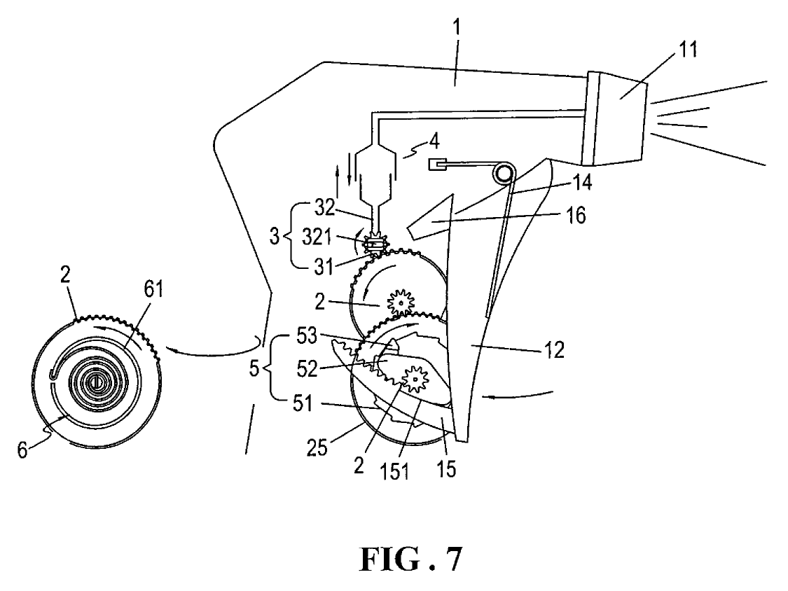

As may be deduced from the drawings of FIGS. 6 and 7, the first lever 12 is restored to its original, non-engaged position by the resilient element 14 and the rotatable piece 52 of the gravity wheel 25 is turned in an opposite direction. However, due to that the blocks 53 are not blocked by the ratchets 51, the gravity wheel 25 does not engages the gear set 2.

As shown in FIGS. 6 and 7, the first lever 12 may further has a brake piece 16 extended into the body of the sprayer 1. The brake piece 16 is configured such that, when the first lever 12 is at its original, non-engaged position, the brake piece 16 has one end touching the circumference of the gear set 2 to prevent the gear set 2 from turning. When the first lever 12 is pressed, the brake piece 16 is turned away to allow the gear set 2 to turn. Therefore, when the first lever 12 is released, the brake piece 16 will again touch the circumference of the gear set 2 to prevent it from working on the eccentric gear 31 to produce sprays.

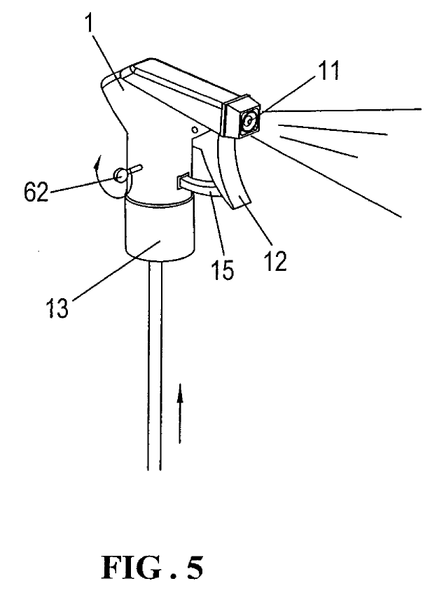

As shown in FIG. 5, instead of winding the spring 61 by pressing the first lever 12, the spring 61 could be wound by a stem winder 62 as well. The stem winder 62 has one end connected to the center of the spring 61 and the other end exposed out of a lateral side of the body.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method for controlling a sprayer, comprising the steps of:
exerting a linear pressure on a lever of said sprayer;
converting said linear pressure into a rotational force of a wheel whose rotational direction changes intermittently by continuously engaging a clutch means and storing energy of said rotational force when said wheel is turned in a first direction;
converting said rotational force of said wheel into a continuous back-and-forth force of a shaft by continuously engaging an eccentric means and releasing the stored energy to increase said back-and-forth force; and
directing said back-and-forth force on a pump of said sprayer to produce a plurality of sprays.

2. The method according to claim 1, further comprising the step of storing energy of an external rotational force before exerting said linear pressure.

3. The method according to claim 1, wherein said clutch means tuns said wheel in a direction and then allows said wheel to turn freely in a reversed direction.

4. The method according to claim 1, wherein said eccentric means puts said shaft into a back-and-forth movement.

5. An automatic continuous sprayer, comprising:
an L-like body having a nozzle in a front end, a bottom end sealing a top opening of a container,
a first lever extended between said first and second ends of said body;
a resilient element between said body and said first lever capable of restoring said first lever back to an original position after said first lever is pressed and released;
a second lever having a first end joined to a lower portion of said first lever and a second end extended into a lower portion of said body, said second lever having a plurality of teeth along an edge of said second lever from said second up to an appropriate distance, said second lever having a plain segment along said edge between said teeth and said first end;
a gravity wheel inside said body engaged by said teeth of said second lever, said gravity wheel having a clutch means so that when, engaged by said second lever, the rotational direction of said gravity wheel changes intermittently between a first direction and a second direction;
a gear set inside said body engaged by said gravity wheel;
an energy storage element inside said body connected to said gear set so that energy is stored in said energy storage element when said gear set is turned in said first direction;
an eccentric means having an eccentric gear engaged by said gear set and a shaft that is put into a back-and-forth movement by said eccentric gear wherein said back-and-forth movement is speeded up in a direction when said gear set is turned in said second direction by said energy storage element's releasing energy;
a pump actuated by said shaft of said eccentric means to produce a plurality of sprays from said nozzle.

6. The sprayer according to claim 5, wherein said clutch means has a plurality of ratchets around the inner circumference of said gravity wheel, a rotatable piece diametrically and pivotally mounted inside said gravity wheel and engaged by said teeth of said second gear, a flexible block is provided at two opposing ends of said rotatable piece, respectively, to interact with said ratchets so that said gravity wheel is driven in said first direction by said teeth of said second lever and then allowed to turn freely in said second direction.

7. The sprayer according to claim 5, wherein said shaft is T-shaped and has an elongated hole on one end of said shaft connected to said gear set.

8. The sprayer according to claim 5, wherein said first lever has a brake piece whose one end is extended into said body of said sprayer, said end of said brake piece touches the circumference of said second gear to prevent said second gear from tuning when said first lever is at a non-engaged position.

9. The sprayer according to claim 5, wherein said energy storage element is a winding spring.

10. The sprayer according to claim 5, wherein said energy storage element is a winding spring.

11. The sprayer according to claim 10, further comprising a stem winder whose one end is connected to the center of said winding spring and the other end is exposed out of said body for winding up said winding spring.
